(19) United States
(12) Patent Application Publication
(10) Pub. No.: US 2026/0301148 A1
(43) Pub. Date: Oct. 1, 2026

(54) RAILWAY ANOMALY DETECTION METHOD AND SYSTEM BASED ON MULTI-MODAL DATA FUSION

(71) Applicant: CRSC COMMUNICATION & INFORMATION GROUP COMPANY LTD., Beijing (CN)

(72) Inventors: Jing LUO, Beijing (CN); Zhe CHEN, Beijing (CN); Xiangbin KONG, Beijing (CN); Yang LIU, Beijing (CN); Mingkun ZHOU, Beijing (CN)

(73) Assignee: CRSC COMMUNICATION & INFORMATION GROUP COMPANY LTD., Beijing (CN)

(21) Appl. No.: 19/480,348

(22) PCT Filed: Jul. 10, 2024
(86) PCT No.: PCT/CN2024/104647

§ 371 Date: Oct. 30, 2025

(30) Foreign Application Priority Data
Oct. 31, 2023 (CN) 202311427216.1

(51) Int. Cl. G06T 7/00; G06T 7/10; G06V 10/26; G06V 10/764; G06V 10/80; G06V 10/82

(52) U.S. Cl. CPC G06T 7/0004; G06T 7/10; G06V 10/26; G06V 10/764; G06V 10/806; G06V 10/82; G06T 2207/10028; G06T 2207/20084; G06T 2207/20221

(57) ABSTRACT

This disclosure relates to a railway anomaly detection method and a system thereof based on multi-modal data fusion, comprising the following steps: encoding respective modal data acquired from railway environments, and concatenating the encoded multi-modal data features; wherein the modal data comprises 1D vibration signals, 2D image data, and 3D point cloud information; performing automatic weight classification on the concatenated multi-modal data features through an attention mechanism to obtain weighted feature vectors fused with multi-modal information; inputting the feature vectors with positional encoding into a Segment Anything Model (SAM) encoder to generate segmentation results; and determining railway anomalies based on the segmentation results. This disclosure demonstrates high monitoring accuracy, real-time responsiveness, and targeted detection capabilities.

### TECHNICAL FIELD

The disclosure relates to the technical field of railway image segmentation and monitoring, particularly to a railway anomaly detection method and a system thereof based on multi-modal data fusion.

### BACKGROUND

In the field of image segmentation and monitoring, multi-modal data processing has emerged as a critical research direction. However, most existing solutions primarily focus on single data types such as images or video streams, lacking comprehensive analysis of multiple data modalities (e.g., vibration signals, images, and 3D point clouds).

The Segment Anything Model (SAM) represents an advanced image segmentation framework with the following key features: 1. Promptable Programmability: SAM enables zero-shot or few-shot transfer learning through programmable prompts, adapting to new image distributions and tasks; 2. Efficient: Equipped with a high-performance image encoder and prompt encoder, SAM generates segmentation masks in real time within web browsers; 3. Ambiguity Awareness: when provided with ambiguous or multi-modal prompts, SAM can produce multiple valid segmentation masks; 4. Large-scale Dataset (SA-1B): trained on the SA-1B dataset containing over 11 million images and 1 billion segmentation masks, SAM demonstrates strong generalization capabilities. However, SAM is predominantly designed for single-modality image data and lacks integrated processing of multi-modal information. This limitation may lead to incomplete insights or misjudgments in specialized application scenarios such as railway monitoring, where contextual understanding across diverse data types is critical.

In the context of SAM-based image segmentation and visual tasks, the Vision Transformer architecture (particularly its large variant ViT-H) has emerged as a popular model choice. ViT-H typically employs pretrained image encoders to process 2D image data, converting images into sequential feature maps that are subsequently utilized for generating segmentation masks or executing other visual tasks. The fundamental processing pipeline of the ViT-H model includes image preprocessing, flattening and patching, linear embedding, positional encoding, and feature extraction via Transformer encoders.

Multi-modal data processing encompasses three primary modalities: 1D vibration signals, 2D image data, and 3D point cloud information. Key applications comprise: 1) 1D Vibration Signals: beyond detecting physical conditions of railway tracks, this data type supports real-time monitoring of train operational status (e.g., predicting potential failures through vibration pattern analysis); 2) 2D Image Data: serving dual purposes of object recognition/tracking and scene understanding (e.g., identifying ground/track conditions via image segmentation); 3) 3D Point Cloud Information: providing spatial structural insights while enabling advanced tasks like 3D reconstruction or fusion with 2D image data for comprehensive scene representation. Conventional multi-modal data fusion approaches often rely on static weighting mechanisms, which may compromise real-time performance and accuracy in railway monitoring applications where dynamic contextual adaptation is critical.

Railway protection zones are predefined areas designated for monitoring and safeguarding railway infrastructure, including tracks, signaling equipment, transportation hubs, and other critical assets. These zones are exposed to diverse security risks, including but not limited to unauthorized intrusions, equipment malfunctions, and track integrity issues. Consequently, railway monitoring systems must meet stringent requirements for real-time performance, operational accuracy, and system security. The aforementioned limitations underscore the necessity for an innovative multi-modal data processing solution tailored specifically to address the unique challenges and demanding requirements of railway monitoring applications.

### SUMMARY

In response to the aforementioned issues, the present disclosure aims to provide a railway anomaly detection method and a system thereof based on multi-modal data fusion characterized by high monitoring accuracy, real-time responsiveness, and application-specific adaptability.

In order to achieve the aforementioned objective, the present disclosure adopts the following technical solution: a railway anomaly detection method based on multi-modal data fusion, comprising the steps of: encoding each modality of data acquired from the railway environment (including 1D vibration signals, 2D image data, and 3D point cloud information) and concatenating the encoded features of each modality; employing an attention mechanism to perform automatic weight classification on the concatenated multi-modal features, thereby generating a weighted feature vector that integrates multi-modal information; adding positional encoding to the feature vector and inputting it into a SAM (Segment Anything Model) encoder to obtain segmentation results; and determining railway anomalies based on the segmentation results.

Furthermore, prior to encoding the 2D image data, the method further comprises:
calculating a protection zone mask based on the 2D image data and performing multi-modal preprocessing on the mask; and
multiplying the preprocessed protection zone mask with the image data in an element-wise manner before proceeding with image data encoding.

Furthermore, the multi-modal preprocessing of the protection zone mask involves: replacing all pixel values outside the protection zone with zero to emphasize critical information within the railway protection area.

Additionally, the protection zone mask is dynamically adjusted using 1D vibration signals and/or 3D point cloud data to form adaptive dynamic protection zones.

Furthermore, dynamic adjustment of the protection zone mask using 1D vibration signals involves:
establishing a dynamic threshold based on 1D vibration signals, when detected vibration exceeds this threshold, the system dynamically expands the protection zone by a predefined fixed proportional range to capture additional contextual information; and
analyzing historical 1D vibration signal data to determine whether current vibration patterns represent a sustained condition or an abrupt incident, with subsequent adaptive adjustment of the protection zone boundaries based on this determination.

Furthermore, dynamic adjustment of the protection zone mask using 3D point cloud information involves:
comparing sequential time-frame point cloud data to identify newly emerged or moving point clusters, with subsequent adaptive adjustment of the protection zone boundaries based on detected spatial changes;
implementing distance/density thresholds where point cloud data exceeding these parameters triggers dynamic protection zone expansion;
analyzing 3D point cloud data to determine spatial relationships between objects and railway infrastructure, with automatic protection zone enlargement when objects are detected approaching critical assets; and
conducting contextual analysis using historical 3D point cloud data to identify persistent objects remaining in a location beyond a predefined duration, prompting targeted protection zone expansion for enhanced monitoring.

Furthermore, the encoding process for each modality of data acquired from the railway environment comprises: independent encoding of 1D vibration signals, 2D image data, and 3D point cloud information into 1D feature vectors;
feature extraction for 1D vibration signals using 1D convolutional neural networks (CNNs);
feature extraction for 2D image data using 2D convolutional neural networks;
feature extraction for 3D point cloud information using either 3D CNNs or specialized point cloud processing networks (e.g., PointNet architectures).

Furthermore, the concatenated multi-modal data features undergo automatic weight classification based on the attention mechanism, which comprises:
automatically calculating attention scores from the concatenated multi-modal data features, and deriving the corresponding weights for each feature modality; and
multiplying the obtained weights with the original multi-modal data features to compute a weighted feature vector that integrates multi-modal information through adaptive fusion.

A multi-modal data fusion-based railway anomaly detection system comprises: first processing module configured to encode each modality of data acquired from the railway environment (including 1D vibration signals, 2D image data, and 3D point cloud information) and concatenating the encoded features; second processing module configured to implement attention mechanisms to perform automatic weight classification on the concatenated multi-modal features, generating a weighted feature vector that integrates cross-modal information; anomaly detection module configured to add positional encoding to the feature vector before inputting it into a Segment Anything Model (SAM) encoder to obtain segmentation results, with railway anomalies ultimately determined through analysis of these segmentation outputs.

A computer-readable storage medium storing one or more programs is provided, the programs comprising instructions that, when executed by a computing device, cause the device to perform any of the methods described above.

The present disclosure, through the aforementioned technical solutions, offers the following advantages:
1. Adaptive Weight Allocation: utilizes attention mechanisms to autonomously learn and distribute weights across multi-modal data, enabling flexible and adaptive multi-modal processing.
2. Enhanced Accuracy: integrates multi-modal data (1D vibration signals, 2D images, 3D point clouds) to improve the model's comprehensive understanding of railway and protection zone conditions.
3. Improved Real-Time Performance: incorporates zero-replacement operations for railway protection zones and algorithmic optimizations, enabling rapid and accurate decisions critical for railway safety.
4. Reduced False Alarm Rate: multi-modal input minimizes reliance on single-source data, thereby lowering both false positives and false negatives.
5. Scalability and Cost Efficiency: adapts to diverse inputs and scenarios while reducing manual monitoring requirements and operational expenses.
6. Enhanced Robustness: multi-modal input ensures sustained model performance even when one data source encounters issues.

### BRIEF DESCRIPTION OF THE DRAWINGS

FIG. 1 shows a flowchart of the railway anomaly detection method based on multi-modal data fusion according to an embodiment of the present disclosure; and

FIG. 2 illustrates a network architecture diagram of the multi-modal data fusion-based railway anomaly detection system according to an embodiment of the present disclosure.

### DETAILED DESCRIPTION

In order to clearly illustrate the objectives, technical solutions, and advantages of the embodiments of the present disclosure, the technical solutions of the embodiments will be described in a comprehensive and intelligible manner below with reference to the accompanying drawings. It should be noted that the embodiments described herein represent only partial implementations of the present disclosure rather than exhaustive implementations. All derivative embodiments obtained by persons skilled in the art based on the disclosed implementations without departing from the inventive concept shall fall within the protection scope of the present disclosure.

It is important to clarify that the terminology employed herein serves solely to describe specific implementations and is not intended to limit the exemplary embodiments of the present disclosure. Unless explicitly stated otherwise in context, singular forms also encompass plural forms. Furthermore, when terms such as “comprise” or “include” are used in this specification, they indicate the presence of stated features, steps, operations, components, modules, and/or combinations thereof, while not precluding the existence or addition of other elements.

The present disclosure provides a railway anomaly detection method and a system thereof based on multi-modal data fusion designed to enhance monitoring accuracy, optimize real-time performance, and increase targeting specificity.

Enhanced Monitoring Accuracy: Traditional railway monitoring systems relying on single-modality data inputs face inherent accuracy limitations. This disclosure improves detection precision by integrating multi-modal data sources (1D vibration signals, 2D images, and 3D point cloud information) while avoiding rigid prior approaches to multi-modal data fusion through implementation of adaptive weight learning mechanisms.

Optimized Real-Time Performance: large-scale segmentation models like SAM may encounter latency issues in real-world applications. The present disclosure addresses this through real-time optimization measures, including a zero-replacement operation on railway protection zones, significantly improving the system's responsive capabilities.

Increased Targeting Specificity: conventional monitoring solutions often lack optimization for railway protection zones. The disclosure introduces specialized preprocessing techniques to better address the unique operational requirements and environmental characteristics of railway infrastructure, enhancing detection relevance and efficiency.

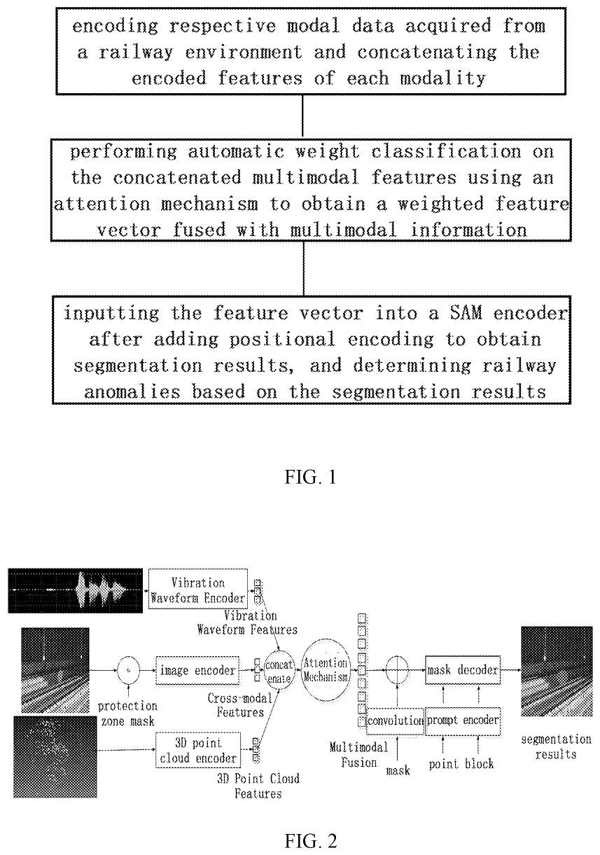

In one embodiment of the present disclosure, a railway anomaly detection method based on multi-modal data fusion is provided. This embodiment constitutes a detection approach in the fields of computer vision and machine learning, specifically addressing image segmentation and multi-modal data processing. Image segmentation technology, which typically partitions digital images into distinct regions or segments, plays a critical role across numerous applications. In railway monitoring scenarios, this technology enables identification and tracking of trains, personnel, obstacles, and other elements, thereby providing more precise and real-time surveillance data. As illustrated in FIGS. 1 and 2, the method comprises the following steps:
encoding respective modal data acquired from the railway environment (including 1D vibration signals, 2D image data, and 3D point cloud information) and concatenating the encoded features of each modality;
performing automatic weight classification on the concatenated multi-modal features using an attention mechanism to generate a novel weighted feature vector that integrates multi-modal information, thereby achieving multi-modal data fusion;
inputting the novel feature vector into a SAM encoder after appending positional encoding to obtain segmentation results, and determining railway anomalies based on the segmentation outcomes.

In step 1), the 1D vibration signals are typically associated with the health status of mechanical equipment, such as axles and tracks. This type of data can be used to detect the physical condition of railway tracks, such as the presence of cracks or other defects.

The 2D image data provides rich visual information, such as object recognition and scene segmentation, and is the most commonly used data type for identifying and tracking target objects.

The 3D point cloud information offers spatial structural information, which is particularly important in railway monitoring for tasks such as obstacle detection and track condition assessment. This data type contributes to more accurate object localization and identification by providing spatial structural context.

In this embodiment, the integration of these heterogeneous data types provides a more comprehensive, accurate, and real-time railway protection zone monitoring method.

In step 1), before encoding the 2D image data, the method further comprises the following steps.
1.1) A protection zone mask is calculated based on the 2D image data and performing multi-modal preprocessing on the mask.

Specifically, railway protection zones are predefined specific areas designated for monitoring and safeguarding railway infrastructure, including tracks, signaling equipment, transportation hubs, and other critical assets. These zones are susceptible to various security risks, including but not limited to unauthorized intrusions, equipment malfunctions, and track irregularities.
1.2) The preprocessed protection zone mask is multiplied with the image data before proceeding with the encoding of the image data.

In step 1.1), the multi-modal preprocessing of the protection zone mask involves: replacing all pixel values outside the protection zone with 0 to focus on critical information within the railway protection zone.

Specifically, the zero-replacement operation for railway protection zones can be mathematically represented as follows. Consider a 2D image data matrix I with dimensions m×n, and a corresponding 2D protection zone mask M of identical dimensions. Within this mask, pixels within the designated protection zone are assigned a value of 1, while pixels outside the zone are set to 0.

The zero-replacement operation is performed using the following formula:

$${I}^{′} = I ⊙ M \qquad ( 1 )$$

In the formula, I′ represents the new image after the zero-replacement operation, and ⊙ denotes element-wise multiplication (Hadamard product).

This operation sets all pixel values outside the protection zone to 0, while retaining the original pixel values within the protection zone.

The formula can be extended to accommodate more complex data structures encompassing additional dimensions or modalities (e.g., vibration signals or 3D point clouds). This zero-replacement operation serves as a straightforward yet effective technique for directing the model's attention to specific protection zones, thereby enhancing the performance and reliability of railway monitoring applications.

In this embodiment, the protection zone mask undergoes dynamic adjustment using 1D vibration signals and/or 3D point cloud information to form dynamic protection zones.

Optionally, dynamic adjustment of the protection zone mask via 1D vibration signals may employ one or a combination of the following two approaches:

Threshold-based judgment: a dynamic threshold is established using 1D vibration signals. When detected vibration exceeds this threshold, it indicates an anomaly, prompting dynamic expansion of the protection zone by a predefined fixed proportion to capture additional contextual information.

Context-aware analysis: Historical 1D vibration signal data is analyzed to determine whether current vibrations represent a sustained pattern or an isolated incident. Based on this determination, the protection zone is further adjusted. For persistent vibrations, the zone is expanded to encompass the continuous vibration area for more comprehensive risk monitoring. For sudden incidents, a temporary protection zone is established around the signal source, with duration determined by event severity.

Optionally, dynamic adjustment of the protection zone mask using 3D point cloud information may employ one or a combination of the following four approaches.

Change detection: by comparing point cloud data across consecutive time frames, newly emerged or moved point clusters are identified. The protection zone is dynamically adjusted based on these detected point clusters.

Threshold-based judgment: a distance or density threshold is established. When point cloud data exceeds this threshold, the protection zone is dynamically adjusted accordingly.

Spatial analysis: based on 3D point cloud information, the spatial relationship between objects and railway infrastructure is analyzed. If object proximity to railway facilities is detected, the protection zone is dynamically expanded.

Context-aware analysis: historical 3D point cloud data is utilized for contextual analysis. If an object remains stationary in an area beyond a predefined duration, the protection zone is expanded to comprise that region.

In step 1), the acquired multi-modal data from the railway environment is individually encoded, including: encoding 1D vibration signals, 2D image data, and 3D point cloud information into separate 1D vectors.

For the 1D vibration signals, a 1D Convolutional Neural Network (1D-CNN) is employed for feature extraction, yielding the 1D vibration signal features F1:

$${F}_{1} = 1 D - CNN ( {V}_{1} ) \qquad ( 2 )$$

For the 2D image data, a 2D Convolutional Neural Network (2D-CNN) is employed for feature extraction, yielding the 2D image features F2:

$${F}_{2} = 1 D - CNN ( {V}_{2} ) \qquad ( 3 )$$

For the 3D point cloud information, 3D Convolutional Neural Networks (3D-CNNs) or specialized point cloud networks are employed for feature extraction, yielding the 3D point cloud features F3:

$${F}_{3} = 1 D - CNN ( {V}_{3} ) \qquad ( 4 )$$

In this embodiment, an attention mechanism is employed to dynamically assign weights to these multi-modal data, typically implemented through one or more fully connected layers and an activation function (e.g., Softmax).

In step 2), the concatenated multi-modal data features undergo automatic weight classification through an attention mechanism, which involves the following sub-steps.
2.1) Attention scores is calculated using the concatenated multi-modal data features, and derive the corresponding feature weights from these attention scores.

Specifically, let W denote the weight matrix and b represent the bias term. The attention scores are computed as:

$$Attention Scores = Softmax ( W \cdot [ {F}_{1} , {F}_{2} , {F}_{3} ] + b ) \qquad ( 5 )$$

In the equation, [F₁, F₂, F₃] denotes a concatenated feature vector.
2.2) The weights of multi-modal features are multiplied with the multi-modal features themselves to compute a weighted feature vector that integrates multi-modal information.

Specifically, the weighted feature vector V is calculated using the attention scores:

$$V = [ {ω}_{1} \cdot {F}_{1} , {ω}_{2} \cdot {F}_{2} , {ω}_{3} \cdot {F}_{3} ] \qquad ( 6 )$$

wherein, ω₁, ω₂, ω₃ represent the weights derived from the “Attention Scores”.

Thus, a weighted feature vector fused with multi-modal information is obtained, which, after being concatenated with the original positional encoding, can replace the previous model input.

In the aforementioned embodiments, while the present disclosure utilizes multi-modal data to provide more comprehensive information, it is not limited to this approach. In certain scenarios, a single modality (e.g., using only 2D images) may suffice for railway and defense zone monitoring.

In summary, the disclosure employs multi-modal data fusion to efficiently integrate 1D vibration signals, 2D image data, and 3D point cloud information. By introducing adaptive weight allocation for dynamic weight adjustment, the disclosure can dynamically optimize the contributions of each modality to enhance model accuracy and robustness. Furthermore, the railway defense zone zero-value replacement method not only improves model accuracy but also contributes to enhanced real-time response capabilities.

In one embodiment of the present disclosure, a railway anomaly detection system based on multi-modal data fusion is provided, comprising:
a first processing module configured to encode respective modal data acquired from the railway environment and concatenate the encoded multi-modal data features, wherein the modal data comprise 1D vibration signals, 2D image data, and 3D point cloud information;
a second processing module configured to perform automatic weight classification on the concatenated multi-modal data features using an attention mechanism, thereby obtaining a weighted feature vector fused with multi-modal information; and
an anomaly detection module configured to add positional encoding to the feature vector, input the result into a SAM encoder to obtain segmentation results, and determine railway anomalies based on the segmentation results.

In the aforementioned embodiments, prior to encoding the 2D image data, the method further comprises:
calculating a defense zone mask based on the 2D image data and performing multi-modal preprocessing on the defense zone mask; and
multiplying the preprocessed defense zone mask with the image data before encoding the image data.

Specifically, the multi-modal preprocessing of the defense zone mask comprises: replacing all pixel values outside the defense zone with 0 to focus on critical information within the railway defense zone.

In this embodiment, the defense zone mask is dynamically adjusted using 1D vibration signals and/or 3D point cloud information to form a dynamic defense zone.

Specifically, the dynamic adjustment of the defense zone mask via 1D vibration signals comprises:
setting a dynamic threshold through 1D vibration signals; when the acquired vibration signal exceeds this dynamic threshold, it is considered that an anomaly has occurred, and the defense zone is dynamically expanded by a preset fixed proportion to capture more contextual information.
using historical data of the 1D vibration signals to determine whether the current vibration pattern represents a sustained condition or a sudden incident, with the defense zone being further adjusted based on this determination.

Specifically, the dynamic adjustment of the defense zone mask via 3D point cloud information comprises:
identifying newly emerged or moving point clusters by comparing point cloud data across consecutive time frames, and dynamically adjusting the defense zone based on the identified point clusters;
setting a distance or density threshold to dynamically adjust the defense zone when point cloud data exceeds this threshold;
determining the spatial relationship between objects and railway infrastructure using 3D point cloud information; if an object is detected approaching railway facilities, the defense zone is dynamically expanded;
performing contextual analysis using historical 3D point cloud data; if an object remains stationary in an area beyond a predefined time threshold, the defense zone is expanded accordingly.

In the aforementioned embodiments, encoding the respective modal data acquired from the railway environment comprises: individually encoding the 1D vibration signals, 2D image data, and 3D point cloud information into 1D vectors.

For the 1D vibration signals, feature extraction is performed using a 1D convolutional neural network.

For the 2D image data, feature extraction is performed using a 2D convolutional neural network.

For the 3D point cloud information, feature extraction is performed using either a 3D convolutional neural network or a point cloud network.

In the aforementioned embodiments, the automatic weight classification of the concatenated multi-modal data features using an attention mechanism comprises:
calculating attention scores based on the concatenated multi-modal features and deriving weights for the features from these scores.
multiplying the derived weights with the multi-modal features to compute a weighted feature vector fused with multi-modal information.

The system provided in this embodiment is designed to execute the methods described in the aforementioned embodiments. For specific workflows and detailed content, please refer to the preceding embodiments, which will not be redundantly elaborated here.

In one embodiment of the present disclosure, a computing device is disclosed, which may be a terminal device comprising: a processor, a communications interface, a memory, a display screen, and an input device. The processor, communications interface, and memory are interconnected via a communication bus. The processor provides computational and control capabilities. The memory comprises a non-volatile storage medium and internal memory, where the non-volatile storage medium stores an operating system and computer programs. When executed by the processor, these programs implement the methods described in the aforementioned embodiments, while the internal memory provides an execution environment for the operating system and computer programs residing in the non-volatile storage medium. The communications interface supports wired or wireless communication with external terminals, with wireless communication achievable through technologies such as Wi-Fi, cellular networks, NFC (Near Field Communication), or other protocols. The display screen may be a liquid crystal display (LCD) or an electronic ink display. The input device may comprise a touch-sensitive layer integrated with the display screen, physical buttons, a trackball, or a touchpad mounted on the device housing, as well as externally connected peripherals such as a keyboard, touchpad, or mouse. The processor invokes logical instructions stored in the memory.

Furthermore, when the logical instructions within the aforementioned memory are implemented as software functional units and commercialized or utilized as standalone products, they may be stored on a computer-readable storage medium. Based on this understanding, the technical contributions of the present disclosure, or portions thereof, may be embodied in the form of software products stored on such media. These computer software products, stored on media including but not limited to USB flash drives, portable hard drives, read-only memory (ROM), random-access memory (RAM), magnetic disks, optical discs, or other program-code storage media, contain instructions to enable a computing device (such as a personal computer, server, or network device) to execute all or partial steps of the methods disclosed in the embodiments of the present disclosure.

In one embodiment of the present disclosure, a computer program product is provided. The computer program product comprises a computer program stored on a non-transitory computer-readable storage medium. The computer program comprises program instructions that, when executed by a computer, enable the computer to perform the methods provided in the aforementioned embodiments.

In another embodiment of the present disclosure, a non-transitory computer-readable storage medium is disclosed. This medium stores server instructions that, when executed by a computer, cause it to implement the methods described in the preceding embodiments.

The implementation principles and technical advantages of the aforementioned computer-readable storage medium are analogous to those detailed in the method embodiments, and thus will not be redundantly discussed here.

The present disclosure is described with reference to flowcharts and/or block diagrams of methods, devices (systems), and computer program products in accordance with embodiments of the present disclosure. It shall be understood that each process and/or block within the flowcharts and/or block diagrams, as well as combinations of processes and/or blocks in the flowcharts and/or block diagrams, may be implemented by computer program instructions. These computer program instructions may be provided to a processor of a general-purpose computer, dedicated computer, embedded processor, or other programmable data processing device to generate a machine, such that the instructions executed by the processor of the computer or other programmable data processing device create means for implementing the functions specified in one or more processes of the flowcharts and/or one or more blocks of the block diagrams.

These computer program instructions may also be stored in a computer-readable storage medium that can direct a computer or other programmable data processing device to operate in a specific manner, such that the instructions stored in the computer-readable storage medium produce an article of manufacture comprising instruction means. These instruction means implement the functions specified in one or more processes of the flowcharts and/or one or more blocks of the block diagrams.

These computer program instructions may also be loaded onto a computer or other programmable data processing device, enabling the execution of a series of operational steps on the computer or programmable device to generate a computer-implemented process. Consequently, the instructions executed on the computer or other programmable device provide procedural steps for implementing the functions specified in one or more processes of the flowcharts and/or one or more blocks of the block diagrams.

Finally, it should be noted that the foregoing embodiments are presented solely to illustrate the technical solutions of the present disclosure and are not intended to be limiting. While detailed descriptions of the disclosure have been provided with reference to the aforementioned embodiments, persons skilled in the art will appreciate that modifications or equivalent substitutions may still be made to the technical solutions disclosed in the embodiments. Such modifications or substitutions do not depart from the spirit and scope of the technical solutions outlined in the respective embodiments of the present disclosure.

### CROSS-REFERENCE TO RELATED APPLICATIONS

This application claims priority to Chinese Patent Application No. 202311427216.1, filed on Oct. 31, 2023, the entire content of which is hereby incorporated by reference into this document.

1. A railway anomaly detection method based on multi-modal data fusion, comprising:
encoding respective modal data acquired from a railway environment and concatenating encoded features of each modality, wherein modal data comprises 1D vibration signals, 2D image data, and 3D point cloud information;
performing automatic weight classification on concatenated multi-modal features using an attention mechanism to obtain a weighted feature vector fused with multi-modal information; and
inputting a feature vector into a SAM encoder after adding positional encoding to obtain segmentation results, and determining railway anomalies based on the segmentation results.

2. The railway anomaly detection method based on multi-modal data fusion according to claim 1, further comprising:
calculating a protection zone mask based on the 2D image data and performing multi-modal preprocessing on the protection zone mask; and
multiplying preprocessed protection zone mask with the image data and then encoding the image data.

3. The railway anomaly detection method based on multi-modal data fusion according to claim 2, wherein the performing multi-modal preprocessing of the protection zone mask comprises:
replacing all pixel values outside a protection zone with 0 to focus on critical information within a railway protection zone.

4. The railway anomaly detection method based on multi-modal data fusion according to claim 2, wherein the protection zone mask is dynamically adjusted using 1D vibration signals and/or 3D point cloud information to form a dynamic protection zone.

5. The railway anomaly detection method based on multi-modal data fusion according to claim 4, wherein dynamic adjustment of the protection zone mask using 1D vibration signals comprises:
setting a dynamic threshold based on the 1D vibration signals, and when acquired vibration signals exceed this threshold, dynamically expanding the protection zone by a predefined fixed proportional range to capture additional contextual information; and
analyzing historical vibration signal data to determine whether current vibrations represent a persistent pattern or a sudden incident, and further adjusting the protection zone based on the determination.

6. The railway anomaly detection method based on multi-modal data fusion according to claim 4, wherein dynamic adjustment of the protection zone mask using 3D point cloud information comprises:
identifying newly emerged or displaced point clusters by comparing point cloud data across consecutive time frames, and dynamically adjusting the protection zone based on identified clusters;
setting a distance or density threshold and dynamically adjusting the protection zone when the point cloud data exceeds the threshold;
analyzing spatial relationships between objects and railway facilities using 3D point cloud information, and dynamically expanding the protection zone if object proximity to railway infrastructure is detected;
performing contextual analysis using historical point cloud data and expanding the protection zone if an object remains in a specific area beyond a preset duration.

7. The railway anomaly detection method based on multi-modal data fusion according to claim 1, wherein encoding respective modal data acquired from the railway environment comprises: separately encoding 1D vibration signals, 2D image data, and 3D point cloud information into 1D vectors;
extracting features from 1D vibration signals using a 1D convolutional neural network;
extracting features from 2D image data using a 2D convolutional neural network;
extracting features from 3D point cloud information using a 3D convolutional neural network or point cloud network.

8. The railway anomaly detection method based on multi-modal data fusion according to claim 1, wherein performing automatic weight classification on concatenated multi-modal features using an attention mechanism comprises:
automatically computing attention scores from the concatenated multi-modal features and deriving weights for multi-modal features from the attention scores;
multiplying weights of multi-modal data features with the multi-modal data features to compute a weighted and fused feature vector incorporating multi-modal information.

9. A railway anomaly detection system based on multi-modal data fusion, comprising:
a first processing module configured to encode respective modal data acquired from a railway environment and concatenating encoded features of each modality, wherein modal data comprise 1D vibration signals, 2D image data, and 3D point cloud information;
a second processing module configured to perform automatic weight classification on concatenated multi-modal features using an attention mechanism to obtain a weighted feature vector fused with multi-modal information; and
an anomaly detection module configured to input the feature vector into a SAM encoder after adding positional encoding to obtain segmentation results, and determining railway anomalies based on the segmentation results.

10. A computer-readable storage medium storing one or more programs, wherein the one or more programs comprise instructions which, when executed by a computing device, cause the device to perform the method according to claim 1.
